(19) United States
(12) Patent Application Publication
(10) Pub. No.: US 2005/0013001 A1
(43) Pub. Date: Jan. 20, 2005

(54) Composite micro-structured sheet for diffusing and condensing light

(75) Inventors: I-Kai Pan, Kaohsiung City (TW); Po-Hung Yau, Kaohsiung County (TW); Jain-Sh Lin, Yilan City (TW); Yu-Nan Pao, Hsinchu County (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/668,172

(22) Filed: Sep. 24, 2003

(30) Foreign Application Priority Data
Jul. 17, 2003 (TW) 92119539

(51) Int. Cl. G02B 5/02

(52) U.S. Cl. 359/599; 359/831

(57) ABSTRACT

A composite micro-structured sheet for diffusing and condensing light is disclosed, which includes a substrate having a top surface and a bottom surface, wherein a plurality of straight trenches with an arc cross-section or an micro-lens array is formed on the bottom surface for diffusing the incident light on the bottom surface, and a plurality of rhombus protrusions is formed on the top surface for raising the semi-brightness angle of the light that has passed through the bottom surface.

### BACKGROUND OF THE INVENTION

1. Field of the Invention

The present invention relates to a composite micro-structured sheet for diffusing and condensing light and, more particularly, to a micro-structured sheet having the complex functions of diffusing and condensing light used in a backlight module of a liquid crystal display.

2. Description of Related Art

Currently, there are two types of lighting module for a flat panel display. One is the back type, and the other is the front type. The backlight module is further classified as a side-light (edge-light) type and a directly-under-light (bottom light) type according to their locations of light sources. Wherever the light sources are located, the profile of the light source easily causes a non-uniformity of brightness, shadows, or line defects to the displaying image. Generally, at least one light-diffusing sheet and at least one light-condensing sheet are used for uniformly diffusing the illuminating light and raising the semi-brightness angle so that the shadows and line defects are blurred and the brightness is enhanced. Additionally, some light-diffusing sheets are mounted with micro particles having various sizes and densities for refracting or diffusing the illuminating light as uniformly as possible. However, the illuminating light will be absorbed when passing through the light-diffusing sheet and only about 50% of the original remains, which leads to a low utility rate of illuminating light, likewise the light-condensing sheet is too expensive to lower the manufacturing cost of the backlight module.

Therefore, it is desirable to provide an improved composite micro-structured sheet for diffusing and condensing light to mitigate and/or obviate the aforementioned problems.

### SUMMARY OF THE INVENTION

The object of the present invention is to provide a composite micro-structured sheet for diffusing and condensing light so that the shadows or line defects of an LCD screen are prevented from appearing, the utilizing efficiency of illuminating light is increased, the quantity of optical sheets used is reduced, and the manufacturing cost of illuminating module is economized.

To achieve the object, the composite micro-structured sheet for diffusing and condensing light of the present invention includes a substrate having a top surface and a bottom surface, wherein a plurality of straight trenches with an arc cross-section or a micro-lens array is formed on the bottom surface for diffusing the incident light on the bottom surface, and a plurality of rhombus protrusions is formed on the top surface for raising the semi-brightness angle of the light that has passed through the bottom surface.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a preferred embodiment of the composite micro-structured sheet of the present invention;

FIG. 1b is the vertical view of FIG. 1a;

FIG. 2 is a perspective view of the directly-under-light backlight module of the present invention;

FIG. 3 shows the simulation result of Example 2 of the present invention;

FIG. 4 is the upward view of another preferred embodiment of the composite micro-structured sheet of the present invention;

FIG. 5 shows the simulation result of Example 3 of the present invention.

### DETAILED DESCRIPTION OF THE PREFERRED EMBODIMENT

The substrate of the composite micro-structured sheet of the present invention could optionally be made of transparent materials or semi-transparent and semi-reflecting materials. Preferably, the substrate is made of polymethyl methacrylate (PMMA) or polycarbonate (PC). The method for forming the straight trenches with an arc cross-section of the present invention is not restricted and the straight trenches with an arc cross-section are preferably constructed of a convex pillar lens array or a concave pillar lens array. The size and focal length of the lenses of the convex pillar lens array or the concave pillar lens array are not restricted. Preferably, the size and focal length of the lenses of the convex pillar lens array or the concave pillar lens array are all the same. The spaces between the lenses of the convex lens array or the concave lens array are optionally equal or different, and are preferably different. The method for forming the micro-lens array is not restricted. Preferably, the micro-lens array is constructed of a convex lens array or a concave lens array. The size and focal length of the lenses of the convex lens array or the concave lens array are not restricted. Preferably, the size and focal length of the lenses of the convex lens array or the concave lens array are all the same. The spaces between the lenses of the convex lens array or the concave lens array are optionally equal or different, and are preferably different. The arrangement of the rhombus protrusions of the present invention is not restricted. Preferably, the rhombus protrusions are parallel to each other. The included angle between the straight trench with an arc cross-section and the rhombus protrusion is preferably ranging from 0 to 90 degrees.

### EXAMPLE 1

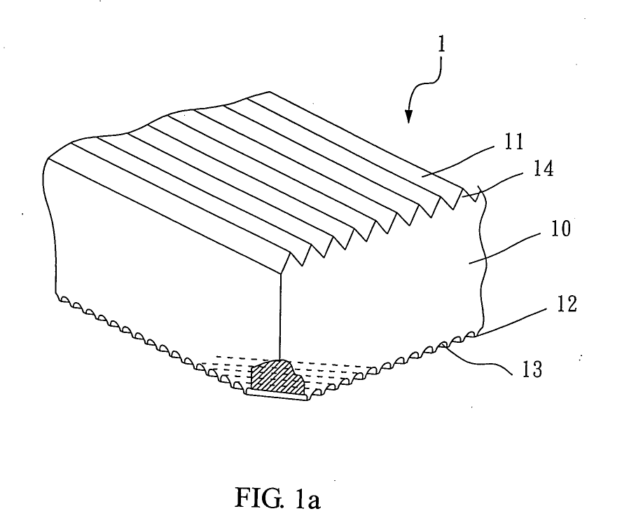

With reference to FIG. 1a, there is shown a perspective view of a preferred embodiment of the composite micro-structured sheet of the present invention. The composite micro-structured sheet 1 is composed of the PMMA substrate 10 having a top surface 11 and a bottom surface 12. On the bottom surface 12, there is formed a plurality of straight trenches 13 that are parallel to each other and constructed of concave pillar lenses, and have an arc cross-section for diffusing the incident light on the bottom surface 12. On the top surface 11, there is formed a plurality of rhombus protrusions 14 for raising the semi-brightness angle of the light that has passed through the bottom surface 12. The rhombus protrusions 14 intersect the straight trenches 13 and the included angle θ therebetween is 30 degrees, as shown in FIG. 1b.

### EXAMPLE 2

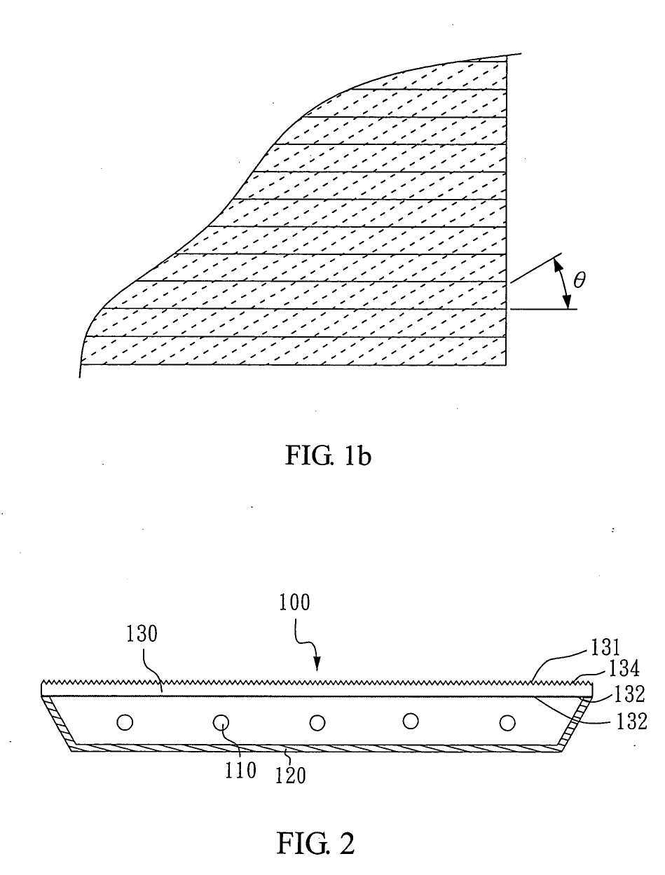

With reference to FIG. 2, there is shown a perspective view of another preferred embodiment of the directly-under-light backlight module of the present invention. The backlight module 100 includes a light source 110, a reflective housing 120, and a composite micro-structured sheet 130. The light source 110 is a cold cathode fluorescent lamp for providing the illuminating light. The reflective housing 120 is adjacent to the light source 110 for receiving the light source 110 and reflecting the illuminating light from the light source 110. The reflective housing 120 is optionally made by stamping or by extrusion. Preferably, the inner surface of the reflective housing 120 is coated with a reflecting and diffusing material for enhancing the reflecting efficiency. The composite micro-structured sheet 130 is the same with the composite micro-structured sheet 1 of Example 1. The composite micro-structured sheet 130 having a top surface 131 and a bottom surface 132 is above the light source 110, wherein the bottom surface 132 is closer to the light source 110 than the top surface 131. A plurality of straight trenches 133 with an arc cross-section is formed on the bottom surface 132 for diffusing the illuminating light from the light source 110. A plurality of rhombus protrusions 134 is formed on the top surface 131. The illuminating light is first diffused by the straight trenches 133 on the bottom surface 132, then passes through the composite micro-structured sheet 130, and finally arrives at the rhombus protrusions 134 on the top surface 131 that raises the semi-brightness angle of the illuminating light, which results in condensing of light and enhancement of brightness.

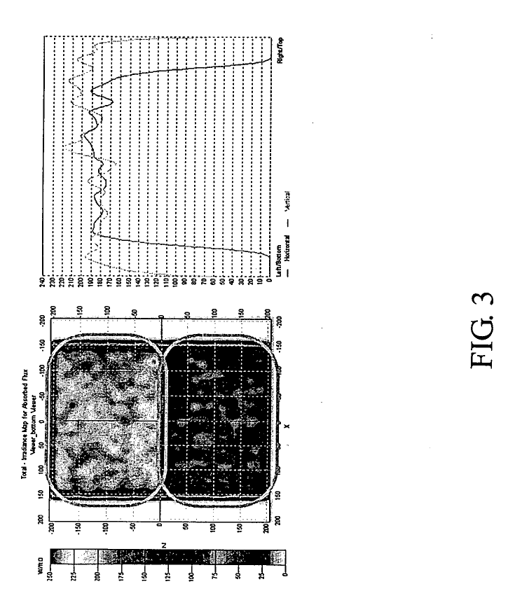

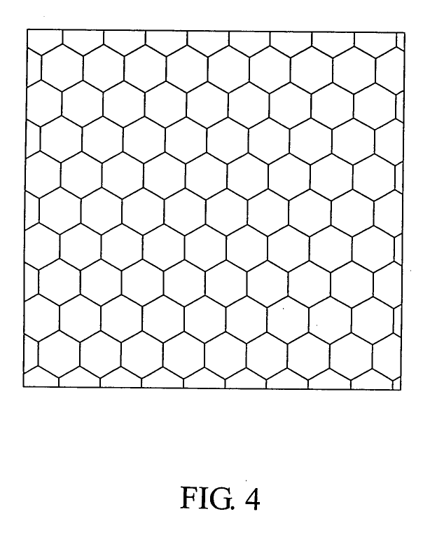

In the following, TracePro™ software is used to simulate the distribution of illuminating light from the backlight module as shown in FIG. 2. The simulation result is shown in FIG. 3, wherein the top half area shows the light distribution of the backlight module that has the composite micro-structured sheet of the present invention, and the bottom half area shows the light distribution of the backlight module that does not have the micro-structured sheet. From FIG. 3 it can be seen that without the micro-structured sheet of the present invention the profile of the lamp could still be seen, that means the illuminating light of the lamp is not effectively dispersed. On the contrary, the micro-structured sheet of the present invention diffuses the illuminating light effectively, which leads to improved uniformity and enhanced brightness of the illuminating light.

### EXAMPLE 3

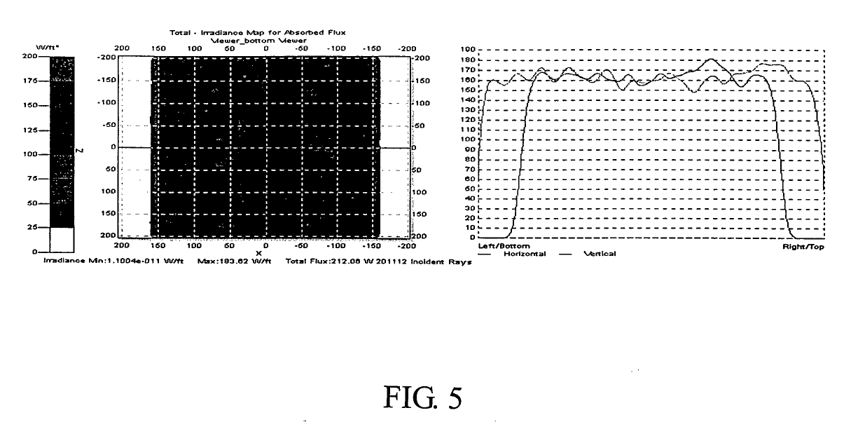

The construction of the present example is very similar to that of Example 2, except that on the bottom surface of the composite micro-structured sheet there is formed a micro-lens array, which is constructed of hexagonal convex lenses that are very close to each other. The simulation result is shown in FIG. 5, which reveals that the composite micro-structured sheet of the present example improves the light uniformity from the backlight module up to 80%.

Traditionally, the backlight module needs 4 or 5 optical sheets to uniformly disperse and condense the illuminating light emitting from the light source. However, those optical sheets are too expensive to reduce the manufacturing cost of the backlight module. The present invention replaces the light diffusing sheet and the prism of the backlight module with a composite micro-structured sheet. Taking advantage of the microstructures, the composite micro-structured sheet has both functions of light diffusing and condensing so that it replaces a plurality of optical sheets. As a result, the quantity of optical sheets used in a backlight module is reduced, which leads to a reduction of weight and production cost of the backlight module. Also, the uniformity and utilizing efficiency of illuminating light are improved vastly and an excellent image quality of a liquid crystal display is obtained.

Although the present invention has been explained in relation to its preferred embodiment, it is to be understood that many other possible modifications and variations can be made without departing from the spirit and scope of the invention as hereinafter claimed.

1. A composite micro-structured sheet for diffusing and condensing light comprising a substrate having a top surface and a bottom surface, wherein a plurality of straight trenches with an arc cross-section or a micro-lens array is formed on the bottom surface for diffusing the incident light on the bottom surface, and a plurality of rhombus protrusions is formed on the top surface for raising the semi-brightness angle of the light that has passed through the bottom surface.

2. The composite micro-structured sheet as claimed in claim 1, wherein the substrate is made of polymethyl mathacrylate (PMMA) or polycarbonate (PC).

3. The composite micro-structured sheet as claimed in claim 1, wherein each straight trench with an arc cross-section is constructed of a convex pillar lens array or a concave pillar lens array.

4. The composite micro-structured sheet as claimed in claim 1, wherein the micro-lens array is composed of a convex lens array or a concave lens array.

5. The composite micro-structured sheet as claimed in claim 3, wherein the size and focal length of the lenses of the convex pillar lens array or the concave pillar lens array are all the same.

6. The composite micro-structured sheet as claimed in claim 4, wherein the spaces between the lenses of the convex lens array or the concave lens array are different.

7. The composite micro-structured sheet as claimed in claim 1, wherein the rhombus protrusions are parallel to each other.

8. The composite micro-structured sheet as claimed in claim 1, wherein an included angle between each straight trench with an arc cross-section and the respective rhombus protrusion ranges from 0 to 90 degrees.
